(19) United States
(12) Patent Application Publication
(10) Pub. No.: US 2026/0050075 A1
(43) Pub. Date: Feb. 19, 2026

(54) HIGH-RESOLUTION RADAR DEVICE FOR DETECTING MOVING TARGET BASED ON BACK PROJECTION AND OPERATION METHOD THEREOF

(71) Applicant: ELECTRONICS AND TELECOMMUNICATIONS RESEARCH INSTITUTE, Daejeon (KR)

(72) Inventors: Seon-Ho HAN, Daejeon (KR); Kyung Hwan PARK, Daejeon (KR)

(21) Appl. No.: 19/260,756

(22) Filed: Jul. 7, 2025

(30) Foreign Application Priority Data
Aug. 19, 2024 (KR) 10-2024-0110442

(51) Int. Cl. G01S 13/42; G01S 7/03; G01S 13/58

(52) U.S. Cl. CPC G01S 13/426; G01S 7/03; G01S 13/58

(57) ABSTRACT

A high-resolution radar device is provided, which includes a transmission antenna, a plurality of reception antennas, a radio frequency (RF) transceiver chip, and a signal processor. The transmit antenna transmits the radar transmit signal to the moving object. The plurality of reception antennas simultaneously receive a plurality of radar receive signals reflected from the moving object, respectively. The RF transceiver chip simultaneously converts the plurality of radar received signals into a plurality of baseband signals, respectively. The signal processor simultaneously back-projects the plurality of baseband signals to detect a location of the moving object.

### CROSS-REFERENCE TO RELATED APPLICATION(S)

This US non-provisional patent application claims priority under 35 USC § 119 to Korean Patent Application No. 10-2024-0110442, filed on Aug. 19, 2024, the entirety of which is hereby incorporated by reference.

### BACKGROUND

### 1. Field of the Invention

The present disclosure relates to a radar device, and more particularly, to a high-resolution radar device that detects a moving object based on back projection and an operation method thereof.

### 2. Description of Related Art

Radar devices are used to detect positions of moving objects. The radar devices include a plurality of receiving antennas, and select one receiving antenna through a switch that selects one of the plurality of receiving antennas. One receiver may receive one radar reception signal received from the selected one reception antenna to detect position coordinates of a moving object based on the radar reception signal.

However, detecting the position of a moving object based on one radar reception signal, rather than using all of a plurality of radar reception signals received from the plurality of reception antennas, has a problem of not accurately detecting the position of the moving object in real time.

### SUMMARY

The present disclosure provides a high-resolution radar device that detects a moving object based on back projection and a method of operating the same.

According to an embodiment of the present disclosure, a high-resolution radar device includes a transmission antenna, a plurality of reception antennas, a radio frequency (RF) transceiver chip, and a signal processor. The transmission antenna transmits a radar transmit signal to a moving object. The plurality of reception antennas simultaneously receive a plurality of radar receive signals reflected from the moving object, respectively. The RF transceiver chip simultaneously converts the plurality of radar received signals into a plurality of baseband signals, respectively. The signal processor simultaneously back-projects the plurality of baseband signals to detect a position of the moving object.

In an embodiment, the high-resolution radar device further comprises a plurality of cables. The plurality of cables connect the transmit antenna and the plurality of reception antennas with the RF transceiver chip, respectively. Lengths of the plurality of cables connecting the plurality of reception antennas with the RF transceiver chip are the same with each other.

In one embodiment, the transmission antenna and the plurality of reception antennas are radially distributed from the RF transceiver chip.

In an embodiment, the RF transceiver chip comprises a transmitter. The transmitter generates the radar transmission signal.

In an embodiment, the RF transceiver chip further comprises a plurality of receivers. The plurality of receivers simultaneously convert the plurality of radar received signals into the plurality of baseband signals, respectively, and simultaneously transmit the plurality of base band signals to the signal processor.

In an embodiment, the signal processor obtains three-dimensional data including distance information and speed information about the moving object based on the plurality of baseband signals, and obtains two-dimensional data based on the speed information in the three-dimensional data.

In an embodiment, the signal processor performs fast fourier transform (FFT) on the plurality of baseband signals to obtain fast time data and slow time data for each position of the plurality of reception antennas, and obtains the three-dimensional data based on the fast time data and the slow time data for the each position of the plurality of reception antenna.

In an embodiment, the signal processor obtains a plurality of variance data based on a signal change of the slow time data for the each position of the plurality of reception antennas, and obtains the two-dimensional data based on the plurality of variance data.

In an embodiment, the signal processor obtains a position coordinate of the moving object from the two-dimensional data based on Equation 1. The Equation 1 is as follows:

$$I [ x , y ] = {\sum }_{n = 1}^{N} E [ {k}_{index} , n ] , where {k}_{index} = floor [ \frac{{t}_{index}}{Δ t} ] ,$$

and

I[x,y] is a position coordinate of the moving object, and N is a number of the plurality of reception antennas, E[k_{index},n] is the n-th reception antenna position data, Δt is a sampling time of fast time data, t_{index} is calculated based on Equation 2. The Equation 2 is as follows:

$${t}_{index} = \frac{\sqrt{{y}^{2} + {( x - {x}_{Tx} )}^{2}} + \sqrt{{y}^{2} + {( x - {x}_{Rx} )}^{2}}}{c} ,$$

and

x is a first directional coordinate of a final position of the radar transmission signal, and y is a second directional coordinate of the final position of the Radar transmission signal, x_{Tx} is a first direction coordinate of the transmit antenna, and x_{Rx} is a first direction coordinate of an n-th reception antenna, and c is a constant.

According to an embodiment of the present disclosure, a high-resolution radar device includes a transmission antenna and a plurality of reception antennas. An operation method of the high-resolution radar device includes transmitting a radar transmission signal to a moving object via the transmission antenna; simultaneously receiving a plurality of radar reception signals reflected from the moving object via the plurality of reception antennas, respectively; simultaneously converting the plurality of radar reception signals into a plurality of baseband signals, respectively; and simultaneously back-projecting the plurality of baseband signals to a position of the moving object.

In an embodiment, the detecting the position of the moving object includes obtaining three-dimensional data including distance information and speed information about the moving object based on the plurality of baseband signals; and obtaining two-dimensional data based on the speed information in the three-dimensional data.

In an embodiment, the obtaining of the three-dimensional data includes: performing fast fourier transform (FFT) on each of the plurality of baseband signals to obtain fast time data and slow time data for each position of the plurality of reception antennas; and obtaining the three-dimensional data based on the fast time data and the slow time data for the each position of the plurality of received antennas.

In an embodiment, the obtaining of the two-dimensional data includes obtaining a plurality of variance data based on a signal change of slow time data for a position of each of the plurality of reception antennas, and obtaining the two-dimensional Data based on the plurality of variance data.

In an embodiment, that the position of the moving object is detected further includes that position coordinates of the moving object are obtained from the two-dimensional data based on an Equation 1. The Equation 1 is as follows:

$$I [ x , y ] = {\sum }_{n = 1}^{N} E [ {k}_{index} , n ] , where {k}_{index} = floor [ \frac{{t}_{index}}{Δ t} ] ,$$

and
I[x,y] is a position coordinate of the moving object, and N is a number of a plurality of reception antennas, E[k_{index},n] is the n th reception antenna position data, Δt is a sampling time of the fast time data, and t_{index} is calculated based on an Equation 2. The Equation 2 is as follows:

$${t}_{index} = \frac{\sqrt{{y}^{2} + {( x - {x}_{Tx} )}^{2}} + \sqrt{{y}^{2} + {( x - {x}_{Rx} )}^{2}}}{c} ,$$

and x is a first directional coordinate of a final position of the radar transmission signal, and y is a second directional coordinate of the final position of the laser transmission signal, x_{Tx} is a first direction coordinate of the transmit antenna, and x_{Rx} is the first direction coordinate of the n-th reception antenna, and c is a constant.

### BRIEF DESCRIPTION OF THE DRAWINGS

The forgoing and other features of inventive concepts will be described below in more detail with reference to the accompanying drawings of non-limiting embodiments of inventive concepts in which like reference characters refer to like parts throughout the different views. The drawings are not necessarily to scale, emphasis instead being placed upon illustrating principles of inventive concepts. In the drawings:

FIG. 1 is a diagram illustrating a high-resolution radar device according to an embodiment of the present disclosure.

FIG. 2 is a flowchart illustrating a method of operating the high-resolution radar device of FIG. 1.

FIG. 3 is a diagram illustrating the RF transceiver chip of FIG. 1.

FIG. 4 is a diagram illustrating another embodiment of the RF transceiver chip of FIG. 1.

FIG. 5 is a diagram illustrating an embodiment of three-dimensional data generated by the signal processor of FIG. 1.

FIG. 6 is a diagram for describing an embodiment of an operation of acquiring two-dimensional data.

FIG. 7 is a diagram illustrating an embodiment of an operation of detecting a position of a moving object.

### DETAILED DESCRIPTION OF THE INVENTION

Hereinafter, embodiments of the present disclosure will be described in a clear and detailed manner to the extent that a person skilled in the art can easily implement the present disclosure.

According to embodiments of the present disclosure, a high-resolution radar device may transmit a radar transmission signal to a moving object and simultaneously receive each of a plurality of radar reception signals reflected from the moving object. The high-resolution radar device may simultaneously convert the plurality of radar reception signals into a plurality of baseband signals, and may simultaneously back-project the plurality of baseband signals to detect a position of the moving object at a high-resolution.

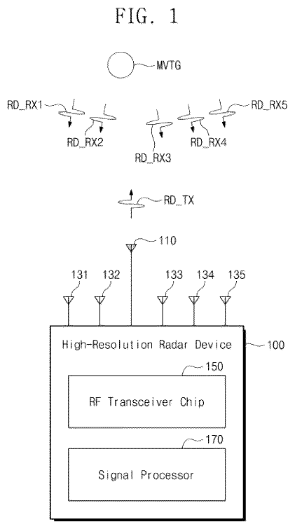

FIG. 1 is a diagram illustrating a high-resolution radar device according to an embodiment of the present disclosure.

Referring to FIG. 1, a high-resolution radar device 100 may include a transmission antenna 110, a plurality of reception antennas 131, 132, 133, 134, and 135, a radio frequency (RF) transmitting and receiving chip 150, and a signal processor 170. In an embodiment, the high-resolution radar device 100 may detect a position of the moving object MVTG in real time.

The transmission antenna 110 may transmit a radar transmission signal RD_TX to the moving object MVTG. For example, the RF transceiver chip 150 may generate a radar transmission signal RD_TX, and the transmission antenna 110 may transmit the radar transmission signal RD_TX to the moving object MVTG.

The plurality of reception antennas 131 to 135 may simultaneously receive each of the plurality of radar reception signals RD_RX1, RD_RX2, RD_RX3, RD_RX4, and RD_RX5. For example, the plurality of radar reception signals RD_RX1 to RD_RX5 may be a plurality of signals on which the radar transmission signal RD_TX is reflected from the moving object MVTG.

The RF transmitting and receiving chip 150 may simultaneously convert each of the plurality of radar reception signals RD_RX1 to RD_RX5 into a plurality of baseband signals. For example, the RF transceiver chip 150 may simultaneously convert the plurality of radar reception signals RD_RX1 to RD_RX5 into a plurality of baseband signals as a preprocessing operation for detecting the position coordinates of the moving object MVTG. For example, the RF transceiver chip 150 may simultaneously convert the first to fifth radar reception signals RD_RX1 to RD_RX5 into the first to fifth baseband signals, respectively.

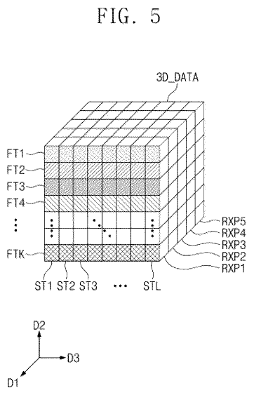

The signal processor 170 may obtain three-dimensional data based on the plurality of baseband signals. For example, the three-dimensional data may include distance information and speed information on the moving object MVTG. The three-dimensional data will be described later with reference to FIG. 5.

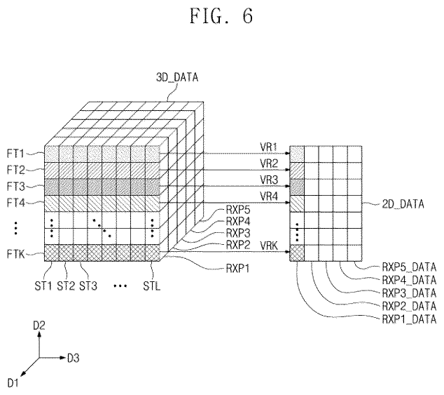

In an embodiment, the signal processor 170 may obtain two-dimensional data based on the three-dimensional data. For example, the signal processor 170 may obtain two-dimensional data based on the speed information on the moving object MVTG in the three-dimensional data. An operation of obtaining two-dimensional data will be described later with reference to FIG. 6.

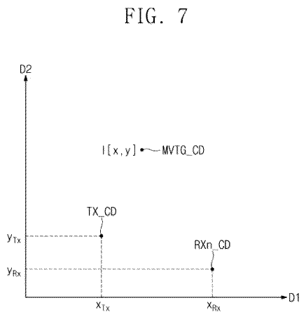

In an embodiment, the signal processor 170 may back-project the two-dimensional data to detect the position of the moving object MVTG. For example, the signal processor 170 may obtain a position coordinates of the moving object MVTG to detect a position of the moving object. The operation of detecting the position of the moving object MVTG will be described later with reference to FIG. 7.

With such a configuration, the high-resolution radar device according to an embodiment of the present disclosure may transmit a radar transmission signal to a moving object and simultaneously receive a plurality of radar reception signals reflected from the moving object. The high-resolution radar device may simultaneously convert a plurality of radar received signals into a plurality of baseband signals, respectively, and may simultaneously back-project the plurality of baseband signals to detect a position of the moving object at a high-resolution.

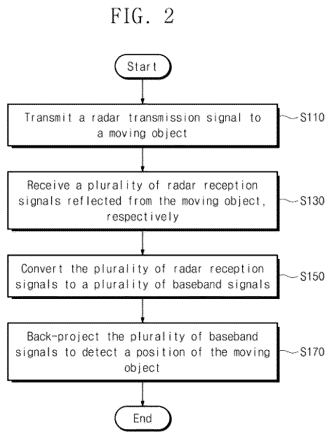

FIG. 2 is a flowchart illustrating an operation method of the high-resolution radar device of FIG. 1.

Referring to FIGS. 1 and 2, in operation S110, the high-resolution radar device 100 may transmit a radar transmission signal RD_TX to a moving object MVTG. For example, the transmission antenna 110 of the high-resolution radar device 100 may transmit the radar transmission signal RD_TX to the moving object MVTG.

In operation S130, the high-resolution radar device 100 may receive a plurality of radar reception signals RD_RX1 to RD_RX5 reflected by the moving object, respectively. For example, the plurality of reception antennas 131 to 135 of the high-resolution radar device 100 may simultaneously receive the plurality of radar reception signals RD_RX1 to RD_RX5 reflected from the moving object MVTG, respectively.

In operation S150, the high-resolution radar apparatus 100 may convert the plurality of radar reception signals RD_RX1 to RD_RX5 into a plurality of baseband signals, respectively. For example, the RF transceiver chip 150 of the high-resolution radar device 100 may simultaneously convert the plurality of radar reception signals RD_RX1 to RD_RX5 into the plurality of baseband signals, respectively. For example, the RF transceiver chip 150 may simultaneously convert the first to fifth radar reception signals RD_RX1 to RD_RX5 into the first to fifth baseband signals, respectively, as a preprocessing operation for detecting a position coordinates of the moving object MVTG.

In operation S170, the high-resolution radar device 100 may back-project the plurality of baseband signals to detect a position of the moving object MVTG. For example, the signal processor 170 of the high-resolution radar device 100 may obtain three-dimensional data based on the plurality of baseband signals. For example, the signal processor 170 may obtain two-dimensional data based on the three-dimensional data. For example, the signal processor 170 may back-project the two-dimensional data to detect the position of the moving object MVTG.

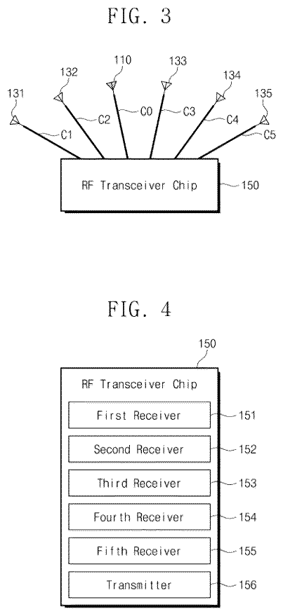

FIG. 3 is a diagram illustrating the RF transceiver chip of FIG. 1.

Referring to FIGS. 1 and 3, the transmission antenna 110 in FIG. 3 may correspond to the transmission antenna 110 of FIG. 1, the plurality of reception antennas 131 to 135 in FIG. 3, may correspond to the plurality of reception antennas 131 to 135 of FIG. 1, and the RF transceiver chip 150 in FIG. 3 shall correspond to the RF transmission/reception chip 150 of FIG. 1. A redundant description will be omitted in comparison with the embodiments shown in FIG. 1.

In an embodiment, the high-resolution radar device 100 may further include a plurality of cables C0, C1, C2, C3, C4, and C5. For example, the 0-th cable C0 may connect the transmit antenna 110 with the RF transceiver chip 150. For example, the first to fifth cables C1 to C5 may connect the plurality of reception antennas 131 to 135 with the RF transceiver chip 150, respectively.

In an embodiment, lengths of the first to fifth cables C1 to C5 may be the same with each other. For example, the lengths of the first to fifth cables C1 to C5 are the same with each other, so that the plurality of radar reception signals RD_RX1 to RD_RX5 received from the plurality of reception antennas 131 to 135 may be simultaneously transferred to the RF transceiver chip 150. For example, the plurality of radar reception signals RD_RX1 to RD_RX5 transferred to the signal processor 170 at the same time may be simultaneously processed by the signal processor 170. For example, by the above processing, the position of the moving object MVTG may be detected at a high-resolution.

In an embodiment, the plurality of reception antennas 131 to 135 may be distributed and arranged from the RF transceiver chip 150. For example, the plurality of reception antennas 131 to 135 may be connected to the RF transceiver chip 150 by the plurality of cables C0 to C5, respectively, and the plurality of reception antennas 131 to 135 may be radially distributed and arranged from the RF transceiver chip 150. For example, the radially distributed arrangement may mean that the plurality of reception antennas 131 to 135 are arranged at equal distance around the RF transceiver 150. For example, reception antennas adjacent to each other may form the same distance.

FIG. 4 is a diagram illustrating another embodiment of the RF transceiver chip of FIG. 1.

Referring to FIG. 1 and FIG. 4, the RF transceiver chip 150 of FIG. 4 may correspond to the RF transceiver chip 150 in FIG. 1. In comparison with the embodiment shown in FIG. 1, redundant description will be omitted.

In an embodiment, the RF transceiver chip 150 may include a plurality of receivers 151, 152, 153, 154, 155 and a transmitter 156.

In an embodiment, the transmitter 156 may generate the radar transmission signal RD_TX. For example, the transmitter 156 may generate a radar transmission signal RD_TX and transmit the radar transmission signal RD_TX to the moving object MVTG through the transmission antenna 110.

In an embodiment, the plurality of receivers 151 to 155 may simultaneously receive the plurality of radar reception signals RD_RX1 to RD_RX5. For example, the first to fifth reception antennas 131 to 135 may simultaneously receive the first to fifth radar reception signals RD_RX1 to RD_RX5 reflected from the moving object MVTG, respectively, and the first to fifth receivers 151 to 155 may simultaneously receive the second to fifth radar reception signal RD_RX1 to RD_RX5 from the first to fifth reception antennas 131 to 135, respectively.

FIG. 5 is a diagram illustrating an embodiment of three-dimensional data generated by the signal processor of FIG. 1.

In FIG. 5, three-dimensional data 3D_DATA is shown. For example, the three-dimensional data 3D_DATA may include position information and speed information about the moving object MVTG.

Referring to FIGS. 1 and 5, the signal processor 170 may obtain three-dimensional data 3D_DATA. For example, the first to fifth reception antennas 131 to 135 may simultaneously receive the first to fifth radar reception signals RD_RX1 to RD_Rx5, respectively. The first to fifth reception antennas 131 to 135 may simultaneously transmit the received first to fifth radar reception signals RD_RX1 to RD_Rx5 to the RF transceiver chip 150. The RF transceiver chip 150 may simultaneously convert the first to fifth radar reception signals RD_RX1 to RD_RX5 into first to fifth baseband signals, respectively, and the signal processor 170 may obtain the three-dimensional data 3D_DATA based on the first to fifth baseband signals.

In an embodiment, the three-dimensional data 3D_DATA may be data defined by the first direction D1, the second direction D2, and the third direction D3. For example, the second direction D2 may be a direction perpendicular to the first direction D1, and the third direction D3 may be a direction perpendicular to a plane defined by the first direction D1 and the second direction D2.

In an embodiment, the three-dimensional data 3D_DATA may include a plurality of reception antenna positions RXP1, RXP2, RXP3, RXP4, and RXP5 arranged along the first direction D1. For example, the first reception antenna position RXP1 may mean a position at which the first reception antenna 131 receives the first radar reception signal RD_RX1 reflected from the moving object MVTG. For example, the second to fifth reception antenna positions RXP2 to RXP5 may mean positions at which the second to fifth reception antennas 132 to 135 receive the second to fifth radar reception signals RD_RX2 to RD_RX5 reflected from the moving object MVTG, respectively.

In an embodiment, the three-dimensional data 3D_DATA may include a plurality of fast time data FT1, FT2, FT3, FT4, . . . and FTK disposed along the second direction D2. For example, the plurality of fast time data FT1 to FTK may include position information of the moving object MVTG. The first to K-th fast time data FT1 to FTK may include position information of the moving object MVTG received by the first reception antenna 131. Although not shown in the drawings, the fast time data including the position information of the moving object MVTG received by the second to fifth reception antennas 132 to 135 may be arranged in the second direction with respect to the second to fifth reception antenna positions RXP2 to RXP5, respectively.

In an embodiment, the signal processor 170 may perform fast fourier transform (FFT) on each of the plurality of baseband signals to obtain a plurality of fast time data FT1 to FTK. For example, the signal processor 170 may perform FFT on one periodic repetition interval PRI of the first baseband signal to obtain the first to K-th fast time data FT1 to FTK. In the same manner as described above, the signal processor 170 may perform FFT on one PRI of each of the second to fifth baseband signals to obtain a plurality of fast time data respectively arranged along the second direction with respect to the second to fifth reception antenna positions RXP2 to RXP5.

In an embodiment, the three-dimensional data 3D_DATA may include a plurality of slow time data ST1, ST2, ST3, . . . and STL disposed along the third direction D3. For example, the plurality of pieces of slow time data ST1 to STL may include speed information of the moving object MVTG. For example, the first to L-th slow time data ST1 to STL may include speed information of the moving object MVTG received by the first reception antenna 131. Although not shown in the drawings, the slow time data including the speed information of the moving object MVTG received by the second to fifth reception antennas 132 to 135 may be arranged in the third direction with respect to the second to fifth reception antenna positions RXP2 to RXP5, respectively.

In an embodiment, the signal processor 170 may perform FFT on a plurality of baseband signals to obtain a plurality of pieces of slow time data ST1 to STL, respectively. For example, the signal processor 170 may perform FFT on a plurality of PRIs of the first baseband signal to obtain the first to L-th slow time data ST1 to STL. In the same manner as described above, the signal processor 170 may perform FFT on a plurality of PRIs of each of the second to fifth baseband signals to obtain a plurality of slow time data, respectively, and the plurality of slow time data are arranged in the third direction with respect to the second to fifth reception antenna positions RXP2 to RXP5, respectively.

FIG. 6 is a diagram for describing an embodiment of an operation of acquiring two-dimensional data.

In FIG. 6, three-dimensional data 3D_DATA and two-dimensional data 2D_DATA are shown. The three-dimensional data 3D_DATA in FIG. 6 may correspond to the three-dimensional data (3D_DATA) in FIG. 5, and redundant description thereof will be omitted.

Referring to FIGS. 1, 5 and 6, the signal processor 170 may obtain a plurality of variance data VR1, VR2, VR3, VR4, . . . and VRK based on signal changes of the plurality of slow time data ST1 to STL. For example, the signal processor 170 may obtain the first variance data VR1 based on a signal change of the first to L-th slow time data ST1 to STL at the first reception antenna position RXP1. The first variance data VR1 may mean a signal change of the first to L-th slow time data ST1 to STL arranged along the third direction D3 of the first fast time data FT1. In the same manner as described above, the signal processor 170 may obtain each of the second to K-th variance data VR2 to VRK based on a signal change of each of the first to L-th slow time data ST1 to STL at the second to fifth reception antenna positions RXP2 to RXP5. For example, each of the second to Kth variance data VR2 to VRK may mean a signal change of each of the first to Lth slow time data ST1 to STL arranged along the third direction D3 of the second to the Kth fast time data FT2 to FTK.

In an embodiment, the signal processor 170 may obtain the two-dimensional data 2D_DATA based on the plurality of variance data. For example, the two-dimensional data 2D_DATA may include a plurality of reception antenna position data RXP1_DATA, RXP2_DATA, RXP3_DATA, RXP4_DATA, and RXP5_DATA. For example, each of the plurality of reception antenna position data RXP1_DATA to RXP5_DATA may refer to data related to each of a plurality of radar reception signals RD_RX1 to RD_RX5 received by a plurality of reception antennas 131 to 135 at each position. For example, the signal processor 170 may obtain the first reception antenna position data RXP1_DATA based on the first to K-th variance data VR1 to VRK. In the same manner as described above, the signal processor 170 may obtain the second to fifth reception antenna position data RXP2_DATA, RXP3_DATA, RXP4_DATA, and RXP5_DATA based on a plurality of variance data for each of the second to fifth reception antenna positions RXP2 to RXP5, respectively.

FIG. 7 is a diagram illustrating an embodiment of an operation of detecting a position of a moving object.

Referring to FIGS. 1, 4, 6, and 7, the position coordinate TX_CD of the transmission antenna 110, a position coordinate RXn_CD of the n-th reception antenna, and a position coordinate MVTG_CD of the moving object MVTG are illustrated. For example, the position coordinate TX_CD of the transmission antenna 110, the position coordinate RXn_CD of the n-th reception antenna, and the position coordinate MVTG_CD of the moving object MVTG may be coordinates defined by the first direction D1 and the second direction D2. For example, the second direction D2 may be a direction perpendicular to the first direction D1.

In an embodiment, the signal processor 170 may back-project the two-dimensional data 2D_DATA to obtain the position coordinates MVTG_CD of the moving object MVTG. For example, the signal processor 170 may obtain the first to fifth reception antenna position data RXP1_DATA to RXP5_DATA based on a plurality of variance data for each of the first to fifth reception antenna positions RXP1 to RXP5, respectively. In an embodiment, the signal processor 170 may back-project the first to fifth receiver position data RXP1_DATA to RXP5_DATA to obtain the position coordinates MVTG_CD of the moving object MVTG.

In an embodiment, the signal processor 170 may back-project the two-dimensional data 2D_DATA based on Equation 1.

$$I [ x , y ] = {\sum }_{n = 1}^{N} E [ {k}_{index} , n ] , where {k}_{index} = floor [ \frac{{t}_{index}}{Δ t} ] \qquad [ Equation 1 ]$$

Referring to Equation 1, I[x,y] may be a position coordinate MVTG_CD of the moving object MVTG, and N may be the number of the plurality of reception antennas 131 to 135 or the number of a plurality of receivers 151 to 155, E[k_{index},n] may be the n-th reception antenna position data, and Δt may be a sampling time of the fast time data. For example, the sampling time of the fast time data may be a sampling time when performing FFT on one PRI of the plurality of baseband signals. For example, t_{index} is the index of the fast time data axis, and may be calculated based on Equation 2.

$${t}_{index} = \frac{\sqrt{{y}^{2} + {( x - {x}_{Tx} )}^{2}} + \sqrt{{y}^{2} + {( x - {x}_{Rx} )}^{2}}}{c} \qquad [ Equation 2 ]$$

Referring to Equation 2, x may be a first direction D1 coordinate of a final position of the radar transmission signal RD_TX, and y may be a second direction D2 coordinate of the final position of the radar transmission signal RD_TX. x_{Tx} may be coordinates of the first direction D1 of the transmission antenna 110, and x_{Rx} may be a coordinate of the first direction D1 of the n-th reception antenna, and c may be a constant.

In one embodiment, the signal processor 170 is further configured to calculate t_{index} for each of the plurality of reception antennas 131 to 135, based on the Equation (2). For example, t_{index} may be calculated based on the Equation 2 for each of the first to fifth reception antennas 131 to 135 and the number of t_{index} may be plural.

In an embodiment, the signal processor 170 is configured to obtain the position coordinates MVTG_CD of the moving object MVTG based on t_{index}. For example, the signal processor 170 may calculate the first to fifth reception antenna position data RXP1_DATA to RXP5_DATA based on a plurality of calculated t_{index}. For example, the signal processor 170 may calculate the position coordinates MVTG_CD of the moving object MVTG based on the first to fifth reception antenna position data RXP1_DATA to RXP5_DATA.

As described above, a high-resolution radar device according to embodiments of the present disclosure may transmit a radar transmission signal to a moving object and simultaneously receive a plurality of radar reception signals reflected from the moving object, respectively. The high-resolution radar device may simultaneously convert a plurality of radar reception signals into a plurality of baseband signals, respectively, and may simultaneously back-project the plurality of baseband signals to detect a position of a moving object at a high-resolution.

The foregoing is specific embodiments for carrying out the present disclosure. The present disclosure will include not only the embodiments described above, but also embodiments that can be simply changed in design or easily changed. In addition, the present disclosure will include techniques that can be easily modified and implemented by using embodiments. Therefore, the scope of the present disclosure should not be limited to the above-described embodiments, but should be defined by the following claims as well as those equivalent to the claims of the present disclosure.

What is claimed is:

1. A high-resolution radar device comprising:
a transmission antenna configured to transmit a radar transmission signal to a moving object;
a plurality of reception antennas configured to simultaneously receive a plurality of radar receive signals reflected from the moving object, respectively;
a radio frequency (RF) transceiver chip configured to simultaneously convert the plurality of radar reception signals into a plurality of baseband signals; and
a signal processor configured to simultaneously back-project the plurality of baseband signals to detect a position of the moving object.

2. The high-resolution radar device of claim 1, further comprising:
a plurality of cables configured to connect the transmit antenna and the plurality of reception antennas with the RF transceiver chip, respectively, and
wherein lengths of the plurality of cables are the same with each other.

3. The high-resolution radar device of claim 2, wherein the transmit antenna and the plurality of reception antennas are radially distributed from the RF transceiver chip.

4. The high-resolution radar device of claim 1, wherein the RF transceiver chip comprises a transmitter configured to generate the radar transmission signal.

5. The high-resolution radar device of claim 4, wherein the RF transceiver chip further includes a plurality of receivers,
wherein the plurality of receivers are configured to simultaneously convert the plurality of radar reception signals into the plurality of baseband signals, respectively, and to simultaneously transmit the plurality of baseband signals to the signal processor.

6. The high-resolution radar device of claim 1, wherein the signal processor is further configured to:
obtain three-dimensional data including distance information and speed information about the moving object based on the plurality of baseband signals; and
obtain two-dimensional data based on the speed information in the three-dimensional data.

7. The high-resolution radar device of claim 6, wherein the signal processor is further configured to:
perform a fast fourier transform (FFT) on each of the plurality of baseband signals to obtain fast time data and slow time data for each position of the plurality of reception antennas; and
obtain the three-dimensional data based on the fast time data and the slow time data for the each position of the plurality of reception antennas.

8. The high-resolution radar device of claim 7, wherein the signal processor is further configured to:
obtain a plurality of variance data based on a signal change of the slow time data for the each position of the plurality of reception antennas; and
obtain the two-dimensional data based on the plurality of variance data.

9. The high-resolution radar device of claim 6, wherein the signal processor is further configured to:
obtain a position coordinate of the moving object from the two-dimensional data based on Equation 1;
wherein the Equation 1 is as follows:
$$I [ x , y ] = {\sum }_{n = 1}^{N} E [ {k}_{index} , n ] , where {k}_{index} = floor [ \frac{{t}_{index}}{Δ t} ] ,$$
wherein I[x,y] is the position coordinate of the moving object, N is a number of the plurality of reception antennas, E[k_{index},n] is an n-th reception antenna position data, Δt is a sampling time of the fast time data, t_{index} is calculated based on Equation 2,
wherein the Equation 2 is as follows:
$${t}_{index} = \frac{\sqrt{{y}^{2} + {( x - {x}_{Tx} )}^{2}} + \sqrt{{y}^{2} + {( x - {x}_{Rx} )}^{2}}}{c} ,$$
and
wherein x is a first directional coordinate of a final position of the radar transmission signal, and y is a second directional coordinate of the final position of the radar transmission signal, x_{Tx} is a first direction coordinate of the transmission antenna, and x_{Rx} is a first direction coordinate of the n-th reception antenna, and c is a constant.

10. An operation method of a high-resolution radar device including a transmit antenna and a plurality of reception antennas, the operation method comprising:
transmitting a radar transmission signal to a moving object via the transmission antenna;
simultaneously receiving a plurality of radar reception signals reflected from the moving object via the plurality of reception antennas, respectively;
simultaneously converting the plurality of radar reception signals into a plurality of baseband signals, respectively; and
simultaneously back-projecting the plurality of baseband signals to detect a position of the moving object.

11. The operation method of claim 10, wherein the detecting the position of the moving object comprises:
obtaining three-dimensional data including distance information and speed information about the moving object based on the plurality of baseband signals; and
obtaining two-dimensional data based on the speed information in the three-dimensional data.

12. The operation method of claim 11, wherein the obtaining the three-dimensional data comprises:
performing fast fourier transform (FFT) on each of the plurality of baseband signals to obtain fast time data and slow time data for each position of the plurality of reception antennas; and
obtaining the three-dimensional data based on the fast time data and the slow time data for the each position of the plurality of reception antennas.

13. The operation method of claim 12, wherein the obtaining the two-dimensional data comprises:
obtaining a plurality of variance data based on a signal change of the slow time data for the each position of the plurality of reception antennas; and
obtaining the two-dimensional data based on the plurality of variance data.

14. The operation method of claim 11, wherein the detecting the position of the moving object further comprises obtaining a position coordinate of the moving object from the two-dimensional data based on Equation 1,
wherein the Equation 1 is as follows:
$$I [ x , y ] = {\sum }_{n = 1}^{N} E [ {k}_{index} , n ] , where {k}_{index} = floor [ \frac{{t}_{index}}{Δ t} ] ,$$
and
wherein I[x,y] is a position coordinate of the moving object, and N is a number of a plurality of reception antennas, E[k_{index},n] is the n th reception antenna position data, Δt is a sampling time of the fast time data, t_{index} is calculated based on Equation 2, wherein the Equation 2 is as follows:
$${t}_{index} = \frac{\sqrt{{y}^{2} + {( x - {x}_{Tx} )}^{2}} + \sqrt{{y}^{2} + {( x - {x}_{Rx} )}^{2}}}{c} ,$$
and
wherein x is a first directional coordinate of a final position of the radar transmission signal, and y is a second directional coordinate of the final position of the radar transmission signal, x_{Tx} is a first direction coordinate of the transmit antenna, and x_{Rx} is a first direction coordinate of an n-th reception antenna, and c is a constant.
